(19) United States
(12) Patent Application Publication
(10) Pub. No.: US 2012/0300944 A1
(43) Pub. Date: Nov. 29, 2012

(54) MEDIA DISTRIBUTION SYSTEM

(75) Inventor: Gary Spittle, Cambridge (GB)

(73) Assignee: CAMBRIDGE SILICON RADIO LIMITED, Cambridge (GB)

(21) Appl. No.: 13/299,586

(22) Filed: Nov. 18, 2011

(30) Foreign Application Priority Data
Dec. 3, 2010 (GB) 1020507.8

(51) Int. Cl. H04J 3/06; H04B 3/00; H04R 5/00; H04B 7/24

(52) U.S. Cl. 381/17; 370/350; 381/77; 381/23

(57) ABSTRACT

A system and method for distributing media data such that the output of that media by a plurality of devices is synchronised. A source device is connected to a plurality of output devices by a plurality of Bluetooth connections and transmits media data and associated indications of time to the output devices. The output devices output the media at the time indicated.

### RELATED APPLICATION

This application claims the benefit of UK Application No. 1020507.8, filed on 3 Dec. 2010, the disclosure of which is incorporated herein by reference in its entirety.

### BACKGROUND

Apparatus and methods for synchronising data transmitted over wireless connections, and in particular Bluetooth® connections, are disclosed.

Bluetooth® is a very widely adopted protocol for enabling wireless connections between devices. The Bluetooth® protocol is a point-to-point protocol in which two devices interact to exchange data. If a single device requires connections to two other devices, independent connections are configured for each other device. Those connections are not synchronised with each other, and may have different sample rates, data rates, and formats, as configured by the two devices. The lack of synchronisation may prevent the use of the Bluetooth® protocol where there is a need for synchronisation between data received at the two devices.

FIG. 1 shows an example in which a source device 10 is connected wirelessly to a left 11 and a right 12 speaker forming a stereo pair. The output of each speaker must be aligned in time to ensure the audio is correctly replicated for the listener. Any misalignment will result in a decrease in the quality of the audio. The two speakers 11, 12 can be connected to the source device by two Bluetooth® connections 13, 14. When data is transmitted on both of these connections the frames of audio for each speaker are formed into packets for the Bluetooth® connection, which packets are interleaved on the radio link for delivery to each speaker, as per the Bluetooth® protocol and shown in FIG. 2.

There is therefore a difference in the time at which the Left and Right speakers 11,12 receive the data, resulting in a delay and misalignment in the audio output. If the left speaker 11 is made aware that there is another speaker in the system, it can delay its output to account for the delay in arrival of the data at that other speaker. However, this does not provide for a robust or accurate system as the delay associated with each speaker is not known accurately, and the delay may vary dependent on the amount of data held in the buffer of each speaker. It is not therefore possible to reliably align the audio output of two speakers connected using two Bluetooth® connections.

In many applications, low-latency is an important characteristic of a wireless connection. For example in telecommunication applications low latency is vital in achieving good quality telephone connections. Low-latency is also important where an audio output must be synchronised with other outputs, for example television pictures, or pictures from a computer game.

Specific protocols for providing low-latency, or synchronised links, have been proposed, but there is a requirement for a synchronised and low-latency wireless system. In particular there is a requirement for a system to provide Bluetooth® wireless connections with these properties.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

There is provided a method of synchronising the output of media by a plurality of output devices, the method comprising the steps of associating timing data representing a time with a first frame of data representing media for output by a first output device, associating timing data representing the time with a second frame of data representing media for output by a second output device, and transmitting the first frame and the associated timing data to the first output device via a first Bluetooth connection, and transmitting the second frame and the associated timing data to the second output device via a second Bluetooth connection.

The method may further comprise the step of, at the represented time, outputting media represented by the first frame from the first output device, and outputting media represented by the second frame from the second output device.

The media may be audio.

The frames of data may be frames of encoded audio data.

The time may be indicated with respect to a common clock of the Bluetooth links.

The method may further comprise the steps of encoding the left channel of an audio signal as the first frame of data, and encoding the right channel of an audio signal as the second frame of data, wherein the first output device is a left speaker, and the second output device is a right speaker.

The steps may be repeated a plurality of times for a sequence of first and second frames, wherein the time associated with each pair of first and second frames is advanced compared to the previous pair of first and second frames.

The time associated with the first and second frames may represent a time at which the first and second output devices are expected to be able to output the media represented by those frames.

The method may further comprise the steps of associating timing data representing the time with a third frame of data representing media for output by a third output device, transmitting the third frame and the associated timing data to the third output device via a third Bluetooth connection.

The method may further comprise the step of outputting media represented by the third frame from the third output device.

The frames of data may represent channels of audio in a surround sound system, and the output devices are speakers configured to output the represented channels of audio. The timing data may be associated with the first and/or second frame of data representing media by encoding the timing data together with the audio data.

The timing data may be associated with the first, second and/or third frame of data by appending the timing information to that frame of data

The method may further comprise the step of transmitting frames of data representing media for output by the first and/or second output device, wherein those frames of data are not associated with timing information.

There is also provided a source device for transmitting data to a plurality of output devices, comprising a processing system configured to associate timing data with first and second frames of data representing media, the timing data indicating a time at which the media represented by the first and second frames of data should be output; a Bluetooth system configured to establish a first Bluetooth connection with a first output device, and a second Bluetooth connection with a second output device, and to transmit the first frame of data and associated time stamp to the first output device, and to transmit the second frame of data and associated time stamp to the second output device.

The processing system may be further configured to encode the left channel of an audio signal as the first frame of data, and encode the right channel of an audio signal as the second frame of data.

The processing system may be further configured to associate timing data indicated the time with a third frame of data representing media, and the Bluetooth system is configured to establish a third Bluetooth connection with the third output device and to transmit the third frame of data represented media to the third output device.

There is also provided a media output device, comprising a Bluetooth system for establishing and maintaining a connection to a source device, and a processing system configured for receiving data representing media for output by the output device from the Bluetooth connection, and outputting the media at a time indicated by a time stamp associated and received with that data.

There is also provided a method of outputting media in synchronisation with the output of media from other, unconnected, devices, the method comprising the steps of receiving via a Bluetooth connection data representing the media and data indicating a time which the media should be output, and outputting the media at the indicated time.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 shows a schematic diagram of a source device and two output devices;

FIG. 2 shows a representation of the transmission of data via two Bluetooth connections;

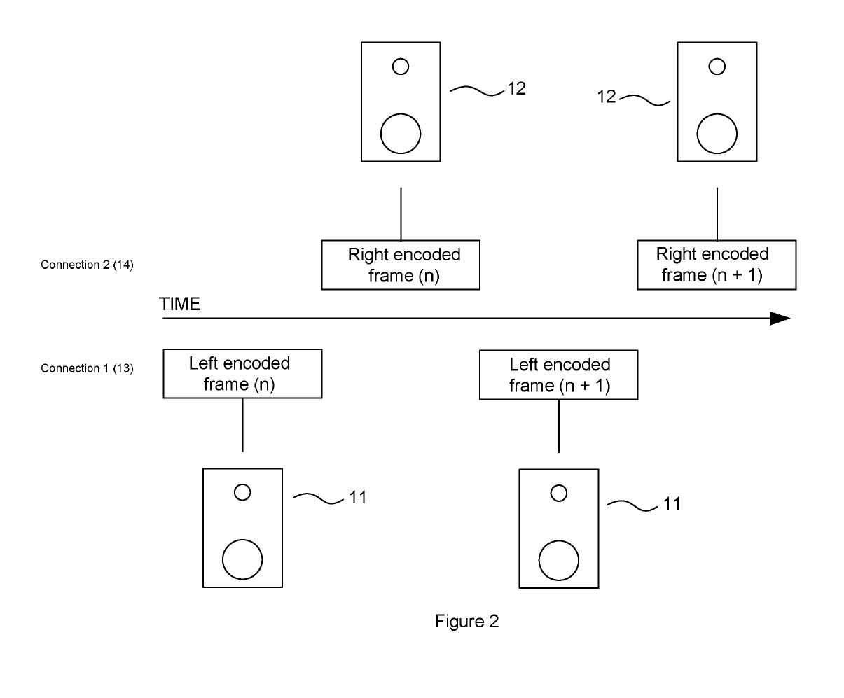

FIG. 3 shows a representation of the transmission of data to synchronise outputs; and

FIG. 4 shows a system for transmitting and outputting synchronised media.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

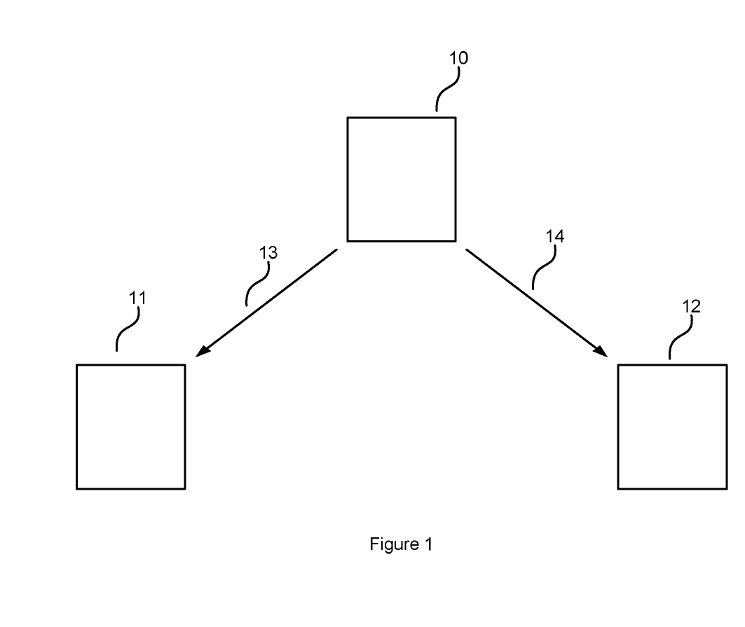

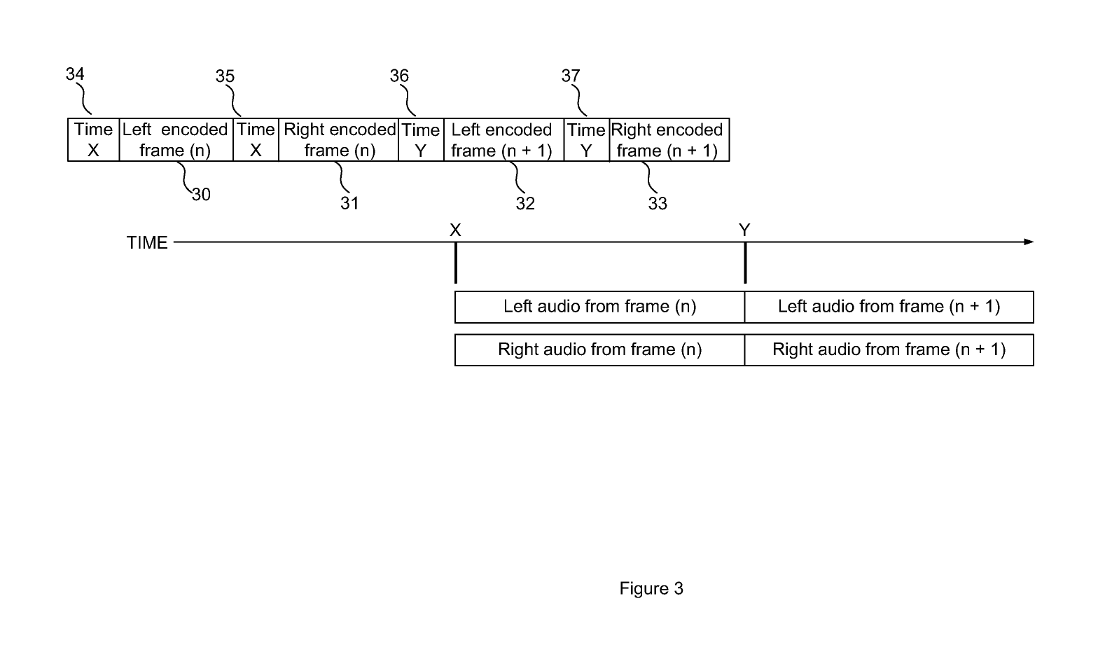

FIG. 3 shows a schematic diagram of data transmission over the Bluetooth® connections described in relation to FIG. 1 to provide a synchronised, low-latency, distribution of data from source device 10 to speakers 11, 12. Source device 10 is configured to encode left and right audio signals into frames 30, 31, 32, 33 for transmission to speakers 11, 12. The frames 30, 32 for the left speaker 11 are transmitted over the first Bluetooth connection 13, and the frames 31, 33 for the right speaker 12 are transmitted over the second Bluetooth connection 14.

For clarity of explanation, in this example it is assumed that the encoded frame and timing information (described below) fits into a single packet such that frames and timing data are not split between packets. In accordance with the Bluetooth® protocol packets are transmitted over the first and second Bluetooth® links alternately, and thus as shown in FIG. 3 frames for the left and right speakers are transmitted alternately.

The source device 10 associates a time stamp 34, 35, 36, 37 with each encoded frame 30, 31, 32, 33 indicating the time at which the audio represented by that frame should be output by the receiving speaker. Since frames 30, 31 represent left and right audio for output at the same time, the same time stamp is associated with both frames. The time is described with reference to the Bluetooth clock that is distributed via the Bluetooth connections from the source device to the output devices.

The time indicated for each frame is selected such that both the left and right speakers will have received, and can output, the relevant frame at the indicated time.

In FIG. 3, the left and right frames 30, 31 are marked for output at time X, which in this example coincides with the end of frame 31. At time X each of the speakers commence output of the audio represented by frame n. The time is indicated with reference to the Bluetooth clock distributed to each of the devices from the source device, and therefore the output from each device commences at the same time. The audio output of the left and right speakers is thus synchronised, despite the Bluetooth connections themselves being unsynchronised. As seen in FIG. 3, while frames 30, 31 are being output, frames 32, 33 are being received ready for output at time Y, which falls at the end of the output of frame 33. A continuous, synchronised, audio output is thus achieved.

No modification of the Bluetooth system is required as the protocols and data formats are unchanged, the time stamp is simply transmitted as regular payload data along with the encoded audio frame.

The use of an absolute time stamp enables the speakers to recover synchronisation even if their buffers become completely empty and output stops. Output can be recommenced at any time once a frame and time stamp are successfully received. As performed in existing systems resampling and resynthesis of frames held in the buffer may be utilised to re-fill the buffer after errors in the communications link.

A small latency is introduced into the system due to the speaker receiving frames first waiting for the second speaker to receive the same frame. Frames 30, 31 are not therefore output instantly, but there is a delay to time X. This delay is dependent on, amongst other parameters, the frame size, and is generally small compared to acceptable latency times. The latency of the system may be varied depending on the configuration.

Typically output devices will include a buffer for storing frames before they are output, such that errors in frames can be accommodated by waiting for retransmission while playing data from the buffer. The use of a buffer increases latency, but also increases robustness. When a buffer is utilised the time for frames to pass through the buffer is accommodated by the time stamp being set to a suitable value. For example, in an MP3 playback system a highly robust, but higher latency system, may be provided by utilising a large buffer size. For television playback, a lower latency system may be utilised by reducing packet, frame, and buffer sizes, which may also lead to a reduction in robustness. Selection of appropriate frame and packet sizes enables efficient use of the wireless connection. For example, very small frame sizes may be utilised to minimise the proportion of frames split between packets.

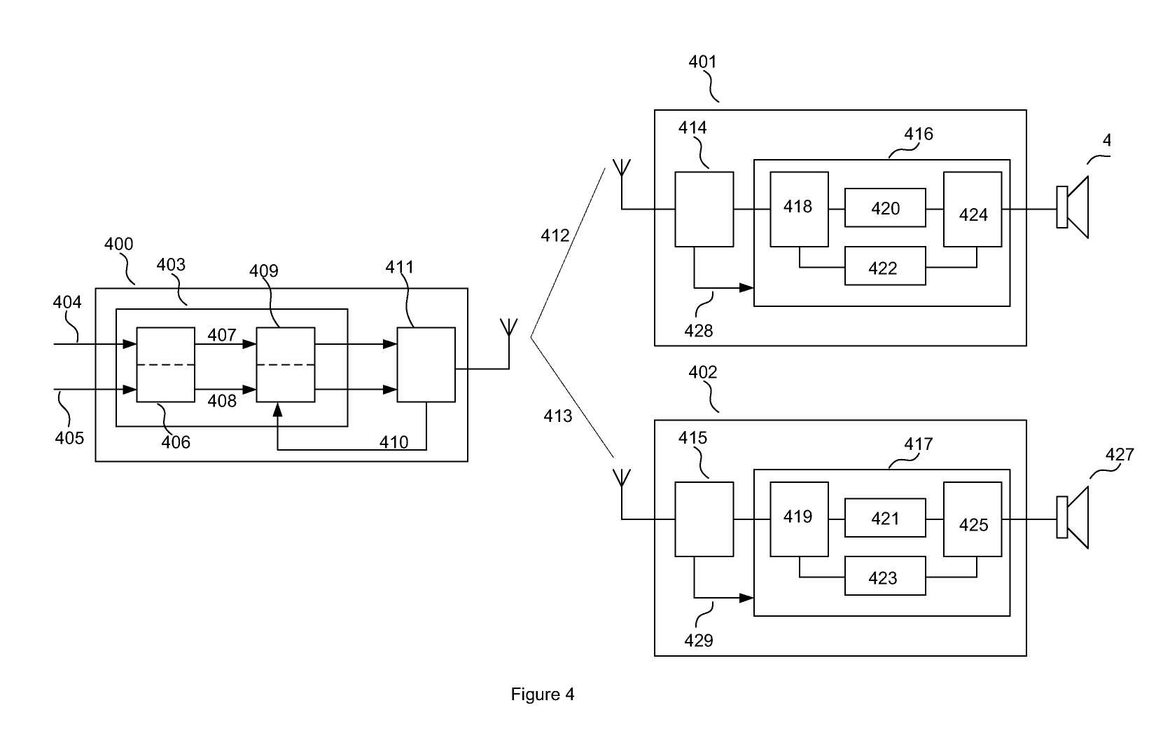

FIG. 4 shows a schematic diagram of a system for implementing the above method for transmitting synchronised audio data from source device 400 to two speakers 401, 402. The source device 400 comprises a processing system 403. Processing system 403 receives Left 404 and Right 405 audio data and comprises a coder 406 for coding that audio data into two coded data streams 407, 408. For example, the coder may code the audio into the SBC or MP3 formats, comprising frames of data. In alternative embodiments the audio signals may be pre-coded, or coded by a separate system, in which case processing system 403 would not provide this coding function.

Processing block 409 associates each frame of the coded data 407, 408 with a time stamp indicating the time at which the audio represented by that frame of data should be output. The time stamp is defined with respect to a Bluetooth® clock 410, which is also distributed to devices connected to the source device 400 via Bluetooth® connections maintained by Bluetooth® system 411.

As explained hereinbefore the time stamp indicates a future time at which all output devices will be in receipt of the data frame and able to output the audio represented by that frame.

Bluetooth® system 411 acts as a master and maintains two Bluetooth® connections 412, 413, one to each of the output speakers 401, 402. The Bluetooth® systems 414, 415 of the speakers are slaves in the Bluetooth® connections to the source device 400.

Bluetooth® system 411 receives the coded audio data with the applied time stamps from processing block 409 and transmits the data corresponding to the left audio channel to the left speaker 401 via Bluetooth® connection 412, and the data corresponding to the right audio channel to the right speaker 402 via Bluetooth® connection 413.

Bluetooth® systems 414, 415 receive the respective data from the source device 400, and communicate it to processing systems 416, 417. Processing blocks 418, 419 separate the time information from the encoded audio frames. The audio frames are stored in frame buffers 420, 421, and the timing information is stored in timing buffers 422, 423. The buffers are configured such that the relation between the time information and audio frames is maintained.

Decoders 424, 425 receive frames from the frame buffers 422, 423, decode the data, and output a signal to speakers 426, 427 representing the audio. Decoders 424, 425 also receive the timing information from timing buffers 422, 423, and the Bluetooth® clock 428, 429, and output the signals at the time indicated by that information. Since both speakers 401, 402 receive clock information from the source device 400, which has used that clock information to define the timing information associated with each frame, the output of each speaker is synchronised at the desired output time.

The blocks and division of functions shown in FIG. 4 is for clarity only, and other divisions or processing steps are possible to provide the same functionality as that provided by FIG. 4. For example, the decoding stage may be performed before the buffer stage, such that any variation in the time taken to decode the frames does not affect the output time. The time indicated by the source device may therefore be utilised as an indication of any particular step in the decoding and output process, provided each device relates the time to the same step.

The output from the decoder may be communicated to an internal or external speaker as appropriate for the particular device.

The above examples have been given by way of reference to a source device distributing data to a stereo pair of speakers. As will be appreciated, this example is not restrictive and the principles described hereinbefore may be utilised in a range of systems. For example, the output devices may be audio-visual output devices in which case the system can be utilised to synchronise a stereo audio output with a visual display. Similarly, the number of output devices may be varied for the particular system. For example the system may be utilised to distribute audio to a system of surround sound speakers comprising 5 or more speakers. For example, a surround sound system offering Dolby 5.1 sound may be connected using Bluetooth® links thereby avoiding physical connections between the speakers and source device. Such a system operates as described hereinbefore, but a Bluetooth connection is utilised between the source and each speaker, with the packets for each connection being interleaved.

In the above embodiments a time stamp is included in every frame, but in alternative embodiments a time-stamp may be included in only some of the frames. For example, in every 5^{th}, 10^{th}, or n^{th} frame. Such a system reduces the data overhead required for transmission of the timing information. In between the frames with the time stamp, the output device is left to free-run based on its internal clock. An indicator is provided to indicate which frames comprise timing information. The frames with which timing information is included may be selected on a dynamic basis based on performance of the connection.

The interval between frames with time stamps may be selected based on a worst-case estimation of possible changes in processing time at the output device (for example changes in buffer size or processing delay) compared to acceptable drift between the output devices. This ensures that an unacceptable variation between output devices will not occur in the time period between time stamps. The output devices may also be configured to monitor their delay and if there is a significant change to resample the available samples or stop output until the next time stamp is available for output, thereby further controlling the possible variation between output devices.

Should the buffer of an output device become empty, and the device's output thereby stop, output can only be restarted once the next frame with a time stamp is received. There is therefore a trade-off between recovery time and data overhead.

In a further variation, the timing data may be added to the audio data and encoded with that audio data by the audio encoder. This scheme removes the data overhead in the encoded frames, but leads to a small increase in distortion of the audio. Consequential changes are made to the receiving system such that the signal is decoded, and the timing information extracted from the decoded data, as will be apparent to the skilled person.

The methods and systems described herein are not restricted to particular types of Bluetooth® connections, and may be implemented, for example, using SCO or A2DP connections. References to Bluetooth® are references to the Bluetooth® family of protocols in general as promoted by the Bluetooth SIG.

The term ‘processing system’ is used herein to refer to any device with processing capability such that it can execute instructions. Those skilled in the art will realize that such processing capabilities are incorporated into many different devices and therefore the term includes, for example, all types of micro-processors, CPUs, GPUs, and DSPs, and multifunction chips.

The methods described herein may be performed by software in machine readable form on a tangible storage medium e.g. in the form of a program comprising program code means adapted to perform all the steps of any of the methods described herein when the program is run on a processing system and where the program may be embodied on a readable medium. Examples of tangible (or non-transitory) storage media include disks, thumb drives, memory etc and do not include propagated signals. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items. Features of each embodiment may be considered in any functioning combination.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description of a preferred embodiment is given by way of example only and that various modifications may be made by those skilled in the art. The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention, including combining features disclosed in respect of one embodiment with features disclosed in respect of a second embodiment.

What is claimed is:

1. A method of synchronising the output of media by a plurality of output devices, the method comprising:
associating timing data representing a time with a first frame of data representing media for output by a first output device;
associating timing data representing the time with a second frame of data representing media for output by a second output device; and
transmitting the first frame and the associated timing data to the first output device via a first Bluetooth connection, and transmitting the second frame and the associated timing data to the second output device via a second Bluetooth connection.

2. A method according to claim 1, further comprising, at the represented time, outputting media represented by the first frame from the first output device, and outputting media represented by the second frame from the second output device.

3. A method according to claim 1, wherein the media is audio.

4. A method according to claim 3, wherein the frames of data are frames of encoded audio data.

5. A method according to claim 4, wherein the timing data is associated with the first and/or second frame of data representing media by encoding the timing data together with the audio data.

6. A method according to claim 1, wherein the time is indicated with respect to a common clock of the Bluetooth links.

7. A method according to claim 1, further comprising encoding the left channel of an audio signal as the first frame of data and encoding the right channel of an audio signal as the second frame of data, wherein the first output device is a left speaker, and the second output device is a right speaker.

8. A method according to claim 1, wherein steps of claim 1 are repeated a plurality of times for a sequence of first and second frames and wherein the time associated with each pair of first and second frames is advanced compared to the previous pair of first and second frames.

9. A method according to claim 1, wherein the time associated with the first and second frames represents a time at which the first and second output devices are expected to be able to output the media represented by those frames.

10. A method according to claim 1, further comprising:
associating timing data representing the time with a third frame of data representing media for output by a third output device; and
transmitting the third frame and the associated timing data to the third output device via a third Bluetooth connection.

11. A method according to claim 10, further comprising outputting media represented by the third frame from the third output device.

12. A method according to claim 10, wherein the frames of data represent channels of audio in a surround sound system, and the output devices are speakers configured to output the represented channels of audio.

13. A method according to claim 1, wherein the timing data is associated with the first, second and/or third frame of data by appending the timing information to that frame of data.

14. A method according to claim 1, further comprising transmitting frames of data representing media for output by the first and/or second output device, wherein those frames of data are not associated with timing information.

15. A source device for transmitting data to a plurality of output devices, comprising:
a processing system configured to associate timing data with first and second frames of data representing media, the timing data indicating a time at which the media represented by the first and second frames of data should be output; and
a Bluetooth system configured to establish a first Bluetooth connection with a first output device, and a second Bluetooth connection with a second output device, and to transmit the first frame of data and associated time stamp to the first output device, and to transmit the second frame of data and associated time stamp to the second output device.

16. A source device according to claim 15, wherein the processing system is further configured to encode the left channel of an audio signal as the first frame of data, and encode the right channel of an audio signal as the second frame of data.

17. A source device according to claim 15, wherein the processing system is further configured to associate timing data indicated the time with a third frame of data representing media, and the Bluetooth system is configured to establish a third Bluetooth connection with the third output device and to transmit the third frame of data represented media to the third output device.

18. A media output device, comprising:
a Bluetooth system for establishing and maintaining a connection to a source device; and
a processing system configured for receiving data representing media for output by the output device from the Bluetooth connection, and outputting the media at a time indicated by a time stamp associated and received with that data.

19. A method of outputting media in synchronisation with the output of media from other, unconnected, devices, the method comprising:
receiving via a Bluetooth connection data representing the media and data indicating a time which the media should be output; and
outputting the media at the indicated time.
